(19) United States
(12) Patent Application Publication
(10) Pub. No.: US 2010/0201701 A1
(43) Pub. Date: Aug. 12, 2010

(54) IMAGE PROCESSOR, IMAGE PROCESSING METHOD, DISPLAY DEVICE, PROGRAM AND INTEGRATED CIRCUIT

(76) Inventor: Bunpei Toji, Gifu (JP)

Correspondence Address: WENDEROTH, LIND & PONACK L.L.P., 1030 15th Street, N.W., Suite 400 East, Washington, DC, 20005-1503, US

(21) Appl. No.: 12/670,738

(22) PCT Filed: May 20, 2009
(86) PCT No.: PCT/JP2009/002225

§ 371 Date: Jan. 26, 2010

(30) Foreign Application Priority Data
Jun. 3, 2008 (JP) 2008-146237

(51) Int. Cl. G09G 5/02

(52) U.S. Cl. 345/589

(57) ABSTRACT

A display device efficiently reduces color unevenness in sub-pixel rendering. A display device (1000) includes a sub-pixel precision image obtaining unit (101), an edge extraction unit (103), and a color uneven area determination unit (104), and performs processing for reducing color unevenness based on the position of an edge between sub-pixels, The display device performs color unevenness reduction processing that produces a stronger effect only in an area in which color unevenness is noticeable, and thus reduces color unevenness sufficiently without degrading a high perceived resolution of an image.

### TECHNICAL FIELD

The present invention relates to an image processing technique using sub-pixel rendering. In particular, the present invention relates to a technique for performing high-definition display by reducing color unevenness that occurs when sub-pixel rendering is used in an image processing apparatus (image processor), a display device, or the like.

### BACKGROUND ART

A pixel of some display devices may be composed of a plurality of regularly arranged RGB light emitting units, which emit red (R), green (G), and blue (B) light. One such display device is a color liquid crystal panel. Each of the light emitting units forming one pixel of such a display device is smaller than the size of one pixel, and is referred to as a “sub-pixel”.

This type of display device forms one line by arranging a plurality of pixels (each consisting of a plurality of sub-pixels) in a direction in which the light emitting units forming one pixel are arranged (for example, in a horizontal direction of a display screen of the display device). The display screen of the display device is formed by arranging a plurality of such lines in a direction orthogonal to the direction in which the light emitting units (sub-pixels) are arranged (for example, in a vertical direction of the display screen of the display device).

FIG. 11A shows an arrangement of sub-pixels for the red (R) component, sub-pixels for the green (G) component, and sub-pixels for the blue (B) component in a display device, and also shows the corresponding data sequence. FIG. 11B shows the structure of a pixel that is composed of sub-pixels.

As shown in FIGS. 11A and 11B, one pixel of this type of display device is composed of three sub-pixels (one for the R component, one for the G component, and one for the B component). The light emitting units (sub-pixels) forming one pixel are arranged in a first direction (horizontal direction). One line is formed by arranging a plurality of pixels in the first direction (horizontal direction). A display screen of the display device is formed by arranging a plurality of pixel groups, each of which forms one line, in a second direction (vertical direction).

As shown in FIG. 11A, the data sequence (represented by a video signal), which is used to illuminate the display device, consists of data elements corresponding one-to-one to the sub-pixels. For example, a data element Yx+1 corresponds to a sub-pixel for the R component pointed by an arrow in FIG. 11A, a data element Yx+2 to a sub-pixel for the G component pointed by an arrow in the figure, and a data element Yx+3 to a sub-pixel for the B component pointed by an arrow in the figure. The sub-pixels for the R component, the G component, and the B component pointed by the arrows in FIG. 11A are illuminated based on the corresponding data elements Yx+1, Yx+2, and Yx+3 of the data sequence (video signal). As a result, the display device forms a video (image).

For example, Patent Citation 1 discloses a technique for improving the clarity of a video (image) displayed by the display device by taking advantage of the characteristics of this type of display device (characteristics of the display device due to its structure in which each pixel is composed of three sub-pixels) and processing (for example, filtering) a video (image) signal (signal forming a display screen of the display device) that is displayed by the display device. This technique improves the display precision (in terms of visual perception) of the display device (the resolution of the display screen actually perceived by humans) (or in other words improves the perceived resolution) to a level exceeding a precision determined by the precision of pixels (the resolution determined by the precision of pixels).

More specifically, to enable the display device to perform sub-pixel rendering, a three-times image, which is an image having a three-times resolution in a direction in which sub-pixels are arranged (for example, in a horizontal direction of the display screen) is generated. The colors of the three-times image are determined by allocating pixels of the three-times image to the corresponding light emitting units (sub-pixels). If this three-times image is displayed by the display device, the resulting image on the display screen will have color unevenness. To prevent this, the three-times image is filtered before displayed. More specifically, a video (image) signal that is used to form the three-times image is filtered using a low-pass filter, which passes only elements having frequencies at which color unevenness is unnoticeable. The filtered video (image) signal for forming the three-times image is then displayed by the display device. This prevents the above color unevenness from occurring on the display screen of the display device. Such processing is needed to prevent color unevenness in a video (image) displayed by the display device, which would occur when an area (image area) sandwiched by edges of an image in the video (image) is narrower than the size of three sub-pixels (when the area consists of high-frequency components). Such color unevenness often occurs in a text part or in an edge part of an image in the video (image) displayed by the display device.

With the conventional technique, for example, the brightness of each pixel is adjusted by multiplying the brightness value of each pixel by a predetermined coefficient, or specifically by multiplying the brightness value of a target pixel in the center by a coefficient of 3/9 times the brightness of the target pixel, multiplying the brightness value of a pixel adjacent to the target pixel by a coefficient of 2/9 times the brightness of the pixel, and multiplying the brightness value of a pixel adjacent to the pixel that is adjacent to the target pixel by a coefficient of 1/9 times the brightness of the pixel.

In this manner, the conventional technique (technique disclosed, for example, in Patent Citation 1) enables sub-pixel rendering by allocating the filtered image to the light emitting units (sub-pixels).

It is known that R, G, and B each have a different contribution to the brightness of the resulting image. In one example, signals may be converted from the RGB color space to the YUV color space. In this case, a Y signal, which corresponds to the brightness (brightness signal), and a U signal and a V signal, which are color signals, can be obtained based on a red (R) signal, a green (G) signal, and a blue (B) signal using the equations below:

Y=0.299R+0.587G+0.114B

U=(B−Y)/2.03=−0.147R−0.289G+0.436B

V=(R−Y)/1.14=0.615R−0.515G−0.100B

In the above conversion equation for the Y signal, the R signal is multiplied by a coefficient of 0.299, the G signal by a coefficient of 0.587, and the B signal by a coefficient of 0.114. Thus, the R, G, and B signals each have a different contribution to (or effect on) the Y signal (the G signal is multiplied by the largest coefficient, meaning that the G signal has the greatest contribution to (or effect on) the Y signal).

Based on this, the filtering may use filter coefficients considering the contribution of each color to the brightness of the resulting image. A sub-pixel rendering technique using filter coefficients considering the contribution of each color to the brightness is disclosed, for example, in Patent Citation 2. Such a sub-pixel rendering technique enables a video (image) displayed on a display device to have a more appropriate display brightness.

Based on the fact that a B signal has a smaller contribution to the brightness, for example, Patent Citation 2 also discloses a sub-pixel precision boldface display technique for selectively displaying in boldface type a pattern in which no light emitting unit corresponding to a B signal is isolated. The technique prevents the perceived contrast at an edge from decreasing.
Patent Citation 1: Japanese Patent No. 3646981
Patent Citation 2: Japanese Unexamined Patent Publication No. 2003-131653

### DISCLOSURE OF INVENTION

### Technical Problem

With the above conventional technique, however, a video (image) to be displayed by the display device is filtered irrespective of whether the video (image) will have color unevenness. The resulting video (image) displayed by the display device may be blurred unnecessarily.

Further, the inventors of the present application have found that color unevenness also occurs in a video (image) displayed on the display device when an area (image area) sandwiched between edges of an image is larger than the size of three sub-pixels, and such color unevenness is particularly noticeable in an area in which the second sub-pixel from an edge is a sub-pixel for the B component (B signal), which has a low contribution to the brightness. However, the above conventional technique fails to selectively process the area in which color unevenness is noticeable.

It is an object of the present invention to provide an image processing apparatus, an image processing method, a display device, a program, and an integrated circuit for processing an area (image area) in which color unevenness is noticeable in a video (image) displayed by a display device through appropriate color unevenness reduction processing.

### Technical Solution

A first aspect of the present invention provides an image processing apparatus for processing an image signal that is displayed on a display screen of a display device. The display screen is formed by arranging a plurality of pixels in a first direction to form a single line of the display screen and arranging a plurality of lines of the display screen in a second direction that is orthogonal to the first direction. Each pixel includes a sub-pixel for a red component, a sub-pixel for a green component, and a sub-pixel for a blue component. The apparatus includes a sub-pixel precision image obtaining unit, an edge extraction unit, a color uneven area determination unit, and a color unevenness selective reduction unit. The sub-pixel precision image obtaining unit obtains a sub-pixel precision image signal for forming a sub-pixel precision image having a sub-pixel precision. The sub-pixel precision is a precision corresponding to the number of sub-pixels. The edge extraction unit extracts edge information from the sub-pixel precision image signal. The color uneven area determination unit determines a color uneven area based on the edge information. The color uneven area is an image area in which color unevenness occurs in the sub-pixel precision image. The reduction unit processes the sub-pixel precision image signal through color unevenness selective reduction processing performed based on information about the color uneven area determined by the color uneven area determination unit. When an edge in the sub-pixel precision image extracted by the edge extraction unit is at a position that is distant from a sub-pixel for a blue component by two sub-pixels in the sub-pixel precision image, the color uneven area determination unit processes the sub-pixel precision image signal corresponding to an image area formed by a pixel including the sub-pixel for the blue component through color unevenness selective reduction processing that produces a first color unevenness reducing effect. When no edge in the sub-pixel precision image extracted by the edge extraction unit is at a position that is distant from a sub-pixel for a blue component by two sub-pixels in the sub-pixel precision image, the color uneven area determination unit processes the sub-pixel precision image signal corresponding to an image area formed by a pixel including the sub-pixel for the blue component through color unevenness selective reduction processing that produces a second color unevenness reducing effect weaker than the first color unevenness reducing effect.

This image processing apparatus processes only an area (image area) in which color unevenness is noticeable using a filter that produces a strong effect (filter that produces a stronger color unevenness reducing effect), and thus enables other areas to maintain a high perceived resolution. As a result, the image processing apparatus obtains an image (including a video) in which color unevenness is reduced in an appropriate manner while enabling the image to maintain a high perceived resolution.

A second aspect of the present invention provides an image processing apparatus for processing an image signal that is displayed on a display screen of a display device. The display screen is formed by arranging a plurality of pixels in a first direction to form a single line of the display screen and arranging a plurality of lines of the display screen in a second direction that is orthogonal to the first direction. Each pixel includes a sub-pixel for a red component, a sub-pixel for a green component, and a sub-pixel for a blue component. The apparatus includes a sub-pixel precision image obtaining unit, an edge extraction unit, a color uneven area determination unit, and a color unevenness selective reduction unit. The sub-pixel precision image obtaining unit obtains a sub-pixel precision image signal for forming a sub-pixel precision image having a sub-pixel precision. The sub-pixel precision is a precision corresponding to the number of sub-pixels. The edge extraction unit extracts edge information from the sub-pixel precision image signal. The color uneven area determination unit determines a color uneven area based on the edge information. The color uneven area is an image area in which color unevenness occurs in the sub-pixel precision image. The color unevenness selective reduction unit processes the sub-pixel precision image signal through color unevenness selective reduction processing performed based on information about the color uneven area determined by the color uneven area determination unit. When an edge in the sub-pixel precision image extracted by the edge extraction unit is at a position that is distant from a sub-pixel for a blue component by two sub-pixels in the sub-pixel precision image, the color uneven area determination unit processes the sub-pixel precision image signal corresponding to an image area formed by two sub-pixels sandwiching the position of the edge in the sub-pixel precision image through color unevenness selective reduction processing that produces a first color unevenness reducing effect. When no edge in the sub-pixel precision image extracted by the edge extraction unit is at a position that is distant from a sub-pixel for a blue component by two sub-pixels in the sub-pixel precision image, the color uneven area determination unit processes the sub-pixel precision image signal corresponding to an image area formed by a pixel including the sub-pixel for the blue component through color unevenness selective reduction processing that produces a color unevenness reducing effect weaker than the first color unevenness reducing effect.

This image processing apparatus processes only a sub-pixel precision image signal corresponding to an image area formed by two sub-pixels sandwiching the position of an edge in the sub-pixel precision image through color unevenness reduction processing that produces a strong effect, and thus obtains an image in which color unevenness is reduced in a more appropriate manner while enabling the image to maintain a high perceived resolution.

A third aspect of the present invention provides the image processing apparatus of the second aspect of the present invention in which in a case when an edge in the sub-pixel precision image extracted by the edge extraction unit is at a position that is distant from a sub-pixel for a blue component by two sub-pixels in the sub-pixel precision image, the color uneven area determination unit processes the sub-pixel precision image signal corresponding to an edge part image area that is an image area formed by two sub-pixels sandwiching the position of the edge in the sub-pixel precision image through color unevenness selective reduction processing that produces a first color unevenness reducing effect. And, in that case, the color uneven area determination unit processes the sub-pixel precision image signal corresponding to an edge adjacent part image area that is an image area formed by at least one sub-pixel sandwiching the edge part image area in the sub-pixel precision image through color unevenness selective reduction processing that produces a second color unevenness reducing effect weaker than the first color unevenness reducing effect. An d, in that case, the color uneven area determination unit processes the sub-pixel precision image signal corresponding to an image area that is other than the edge part image area and the edge adjacent part image area in the sub-pixel precision image through color unevenness selective reduction processing that produces a third color unevenness reducing effect weaker than the second color unevenness reducing effect.

This image processing apparatus processes an edge part image area through color unevenness reduction processing that produces a strong effect in a manner that the effect of such color uneven reduction processing changes gradually over different areas, and thus obtains an image in which color unevenness is reduced in an appropriate manner while enabling the image to maintain a high perceived resolution. Also, such color unevenness reduction processing whose effect does not change drastically reduces color unevenness in a natural-looking manner.

A fourth aspect of the present invention provides the image processing apparatus of one of the first to third aspects of the present invention further including a display device arrangement information input unit that receives input of information about an arrangement of sub-pixels of the display device.

This image processing apparatus performs color unevenness reduction processing in an appropriate manner for display devices with different arrangements of sub-pixels. For example, the display device arrangement information input unit receives input of 0 when the display device uses the RGB arrangement of sub-pixels, and receives input of 1 when the display device uses the BRG arrangement. Based on the input into the display device arrangement information input unit, the image processing apparatus changes (switches) the color unevenness reduction processing.

A fifth aspect of the present invention provides a display device including the image processing apparatus according to one of the first to fourth aspects of the present invention and a display unit that displays an image signal processed by the image processing apparatus.

The display device performs color unevenness reduction processing in an appropriate manner while maintaining a high perceived resolution of an image.

A sixth aspect of the present invention provides an image processing method for processing an image signal that is displayed on a display screen of a display device. T he display screen is formed by arranging a plurality of pixels in a first direction to form a single line of the display screen and arranging a plurality of lines of the display screen in a second direction that is orthogonal to the first direction. Each pixel includes a sub-pixel for a red component, a sub-pixel for a green component, and a sub-pixel for a blue component. The method includes a sub-pixel precision image obtaining process, an edge extraction process, a color uneven area determination process, and a color unevenness selective reduction process. In the sub-pixel precision image obtaining process, a sub-pixel precision image signal for forming a sub-pixel precision image having a sub-pixel precision is obtained. The sub-pixel precision is a precision corresponding to the number of sub-pixels. In the edge extraction process, edge information is extracted from the sub-pixel precision image signal. In the color uneven area determination process, a color uneven area is determined based on the edge information. The color uneven area is an image area in which color unevenness occurs in the sub-pixel precision image. In the color unevenness selective reduction process, the sub-pixel precision image signal is processed through color unevenness selective reduction processing performed based on information about the color uneven area determined in the color uneven area determination process. When an edge in the sub-pixel precision image extracted by the edge extraction step is at a position that is distant from a sub-pixel for a blue component by two sub-pixels in the sub-pixel precision image, the sub-pixel precision image signal corresponding to an image area formed by a pixel including the sub-pixel for the blue component is processed through color unevenness selective reduction processing that produces a first color unevenness reducing effect in the color uneven area determination process. When no edge in the sub-pixel precision image extracted by the edge extraction step is at a position that is distant from a sub-pixel for a blue component by two sub-pixels in the sub-pixel precision image, the sub-pixel precision image signal corresponding to an image area formed by a pixel including the sub-pixel for the blue component is processed through color unevenness selective reduction processing that produces a second color unevenness reducing effect weaker than the first color unevenness reducing effect in the color uneven area determination process.

The image processing method has the same advantageous effects as the image processing apparatus of the first aspect of the present invention.

A seventh aspect of the present invention provides an image processing method for processing an image signal that is displayed on a display screen of a display device. The display screen is formed by arranging a plurality of pixels in a first direction to form a single line of the display screen and arranging a plurality of lines of the display screen in a second direction that is orthogonal to the first direction. Each pixel includes a sub-pixel for a red component, a sub-pixel for a green component, and a sub-pixel for a blue component. The method includes a sub-pixel precision image obtaining process, an edge extraction process, a color uneven area determination process, and a color unevenness selective reduction process. In the sub-pixel precision image obtaining process, a sub-pixel precision image signal for forming a sub-pixel precision image having a sub-pixel precision is obtained. The sub-pixel precision is a precision corresponding to the number of sub-pixels. In the edge extraction process, edge information is extracted from the sub-pixel precision image signal. In the color uneven area determination process, a color uneven area is determined based on the edge information. The color uneven area is an image area in which color unevenness occurs in the sub-pixel precision image. In the color unevenness selective reduction process, the sub-pixel precision image signal is processed through color unevenness selective reduction processing performed based on information about the color uneven area determined in the color uneven area determination process. When an edge in the sub-pixel precision image extracted by the edge extraction step is at a position that is distant from a sub-pixel for a blue component by two sub-pixels in the sub-pixel precision image, the sub-pixel precision image signal corresponding to an image area formed by two sub-pixels sandwiching the position of the edge in the sub-pixel precision image is processed through color unevenness selective reduction processing that produces a first color unevenness reducing effect in the color uneven area determination process. When no edge in the sub-pixel precision image extracted by the edge extraction step is at a position that is distant from a sub-pixel for a blue component by two sub-pixels in the sub-pixel precision image, the sub-pixel precision image signal corresponding to an image area formed by a pixel including the sub-pixel for the blue component is processed through color unevenness selective reduction processing that produces a color unevenness reducing effect weaker than the first color unevenness reducing effect in the color uneven area determination process.

The image processing method has the same advantageous effects as the image processing apparatus of the second aspect of the present invention.

An eighth aspect of the present invention provides a program enabling a computer to implement an image processing method for processing an image signal that is displayed on a display screen of a display device. The display screen is formed by arranging a plurality of pixels in a first direction to form a single line of the display screen and arranging a plurality of lines of the display screen in a second direction that is orthogonal to the first direction. Each pixel includes a sub-pixel for a red component, a sub-pixel for a green component, and a sub-pixel for a blue component. The program enables the computer to implement a sub-pixel precision image obtaining process, an edge extraction process, a color uneven area determination process, and a color unevenness selective reduction process. In the sub-pixel precision image obtaining process, a sub-pixel precision image signal for forming a sub-pixel precision image having a sub-pixel precision is obtained. The sub-pixel precision is a precision corresponding to the number of sub-pixels. In the edge extraction process, edge information is extracted from the sub-pixel precision image signal. In the color uneven area determination process, a color uneven area is determined based on the edge information. The color uneven area is an image area in which color unevenness occurs in the sub-pixel precision image. In the color unevenness selective reduction process, the sub-pixel precision image signal is processed through color unevenness selective reduction processing performed based on information about the color uneven area determined in the color uneven area determination process. When an edge in the sub-pixel precision image extracted by the edge extraction step is at a position that is distant from a sub-pixel for a blue component by two sub-pixels in the sub-pixel precision image, the sub-pixel precision image signal corresponding to an image area formed by a pixel including the sub-pixel for the blue component is processed through color unevenness selective reduction processing that produces a first color unevenness reducing effect in the color uneven area determination process. When no edge in the sub-pixel precision image extracted by the edge extraction step is at a position that is distant from a sub-pixel for a blue component by two sub-pixels in the sub-pixel precision image, the sub-pixel precision image signal corresponding to an image area formed by a pixel including the sub-pixel for the blue component is processed through color unevenness selective reduction processing that produces a second color unevenness reducing effect weaker than the first color unevenness reducing effect in the color uneven area determination process.

The program has the same advantageous effects as the image processing apparatus of the first aspect of the present invention.

A ninth aspect of the present invention provides a program enabling a computer to implement an image processing method for processing an image signal that is displayed on a display screen of a display device. The display screen is formed by arranging a plurality of pixels in a first direction to form a single line of the display screen and arranging a plurality of lines of the display screen in a second direction that is orthogonal to the first direction. Each pixel includes a sub-pixel for a red component, a sub-pixel for a green component, and a sub-pixel for a blue component. The program enables the computer to implement a sub-pixel precision image obtaining process, an edge extraction process, a color uneven area determination process, and a color unevenness selective reduction process. In the sub-pixel precision image obtaining process, a sub-pixel precision image signal for forming a sub-pixel precision image having a sub-pixel precision is obtained. The sub-pixel precision is a precision corresponding to the number of sub-pixels. In the edge extraction process, edge information is extracted from the sub-pixel precision image signal. In the color uneven area determination process, a color uneven area is determined based on the edge information. The color uneven area is an image area in which color unevenness occurs in the sub-pixel precision image. In the color unevenness selective reduction process, the sub-pixel precision image signal is processed through color unevenness selective reduction processing performed based on information about the color uneven area determined in the color uneven area determination process. When an edge in the sub-pixel precision image extracted by the edge extraction step is at a position that is distant from a sub-pixel for a blue component by two sub-pixels in the sub-pixel precision image, the sub-pixel precision image signal corresponding to an image area formed by two sub-pixels sandwiching the position of the edge in the sub-pixel precision image is processed through color unevenness selective reduction processing that produces a first color unevenness reducing effect in the color uneven area determination process. When no edge in the sub-pixel precision image extracted by the edge extraction step is at a position that is distant from a sub-pixel for a blue component by two sub-pixels in the sub-pixel precision image, the sub-pixel precision image signal corresponding to an image area formed by a pixel including the sub-pixel for the blue component is processed through color unevenness selective reduction processing that produces a color unevenness reducing effect weaker than the first color unevenness reducing effect in the color uneven area determination process.

The program has the same advantageous effects as the image processing apparatus of the second aspect of the present invention.

A tenth aspect of the present invention provides an integrated circuit for processing an image signal that is displayed on a display screen of a display device. The display screen is formed by arranging a plurality of pixels in a first direction to form a single line of the display screen and arranging a plurality of lines of the display screen in a second direction that is orthogonal to the first direction. Each pixel includes a sub-pixel for a red component, a sub-pixel for a green component, and a sub-pixel for a blue component. The integrated circuit includes a sub-pixel precision image obtaining unit, an edge extraction unit, a color uneven area determination unit, and a color unevenness selective reduction unit. The sub-pixel precision image obtaining unit obtains a sub-pixel precision image signal for forming a sub-pixel precision image having a sub-pixel precision. The sub-pixel precision is a precision corresponding to the number of sub-pixels. The edge extraction unit extracts edge information from the sub-pixel precision image signal. The color uneven area determination unit determines a color uneven area based on the edge information. The color uneven area is an image area in which color unevenness occurs in the sub-pixel precision image. The color unevenness selective reduction unit processes the sub-pixel precision image signal through color unevenness selective reduction processing performed based on information about the color uneven area determined by the color uneven area determination unit. When an edge in the sub-pixel precision image extracted by the edge extraction unit is at a position that is distant from a sub-pixel for a blue component by two sub-pixels in the sub-pixel precision image, the color uneven area determination unit processes the sub-pixel precision image signal corresponding to an image area formed by a pixel including the sub-pixel for the blue component through color unevenness selective reduction processing that produces a first color unevenness reducing effect. When no edge in the sub-pixel precision image extracted by the edge extraction unit is at a position that is distant from a sub-pixel for a blue component by two sub-pixels in the sub-pixel precision image, the color uneven area determination unit processes the sub-pixel precision image signal corresponding to an image area formed by a pixel including the sub-pixel for the blue component through color unevenness selective reduction processing that produces a second color unevenness reducing effect weaker than the first color unevenness reducing effect.

The integrated circuit has the same advantageous effects as the image processing apparatus of the first aspect of the present invention.

An eleventh aspect of the present invention provides an integrated circuit for processing an image signal that is displayed on a display screen of a display device. The display screen is formed by arranging a plurality of pixels in a first direction to form a single line of the display screen and arranging a plurality of lines of the display screen in a second direction that is orthogonal to the first direction. Each pixel includes a sub-pixel for a red component, a sub-pixel for a green component, and a sub-pixel for a blue component. The integrated circuit includes a sub-pixel precision image obtaining unit, an edge extraction unit, a color uneven area determination unit, and a color unevenness selective reduction unit. The sub-pixel precision image obtaining unit obtains a sub-pixel precision image signal for forming a sub-pixel precision image having a sub-pixel precision. The sub-pixel precision is a precision corresponding to the number of sub-pixels. The edge extraction unit extracts edge information from the sub-pixel precision image signal. The color uneven area determination unit determines a color uneven area based on the edge information. The color uneven area is an image area in which color unevenness occurs in the sub-pixel precision image. The color unevenness selective reduction unit processes the sub-pixel precision image signal through color unevenness selective reduction processing performed based on information about the color uneven area determined by the color uneven area determination unit. When an edge in the sub-pixel precision image extracted by the edge extraction unit is at a position that is distant from a sub-pixel for a blue component by two sub-pixels in the sub-pixel precision image, the color uneven area determination unit processes the sub-pixel precision image signal corresponding to an image area formed by two sub-pixels sandwiching the position of the edge in the sub-pixel precision image through color unevenness selective reduction processing that produces a first color unevenness reducing effect. When no edge in the sub-pixel precision image extracted by the edge extraction unit is at a position that is distant from a sub-pixel for a blue component by two sub-pixels in the sub-pixel precision image, the color uneven area determination unit processes the sub-pixel precision image signal corresponding to an image area formed by a pixel including the sub-pixel for the blue component through color unevenness selective reduction processing that produces a color unevenness reducing effect weaker than the first color unevenness reducing effect.

The integrated circuit has the same advantageous effects as the image processing apparatus of the second aspect of the present invention.

A twelfth aspect of the present invention provides the integrated circuit of one of the tenth and eleventh aspects of the present invention further including a display device arrangement information input unit that receives input of information about an arrangement of sub-pixels of the display device.

### Advantageous Effects

The image processing apparatus, the image processing method, the display device, the program, and the integrated circuit of the present invention enable an area (image area) in which color unevenness is noticeable in a video (image) displayed on a display device to be processed through appropriate color unevenness selective reduction processing.

### BRIEF DESCRIPTION OF DRAWINGS

FIG. 1 is a block diagram showing the structure of a display device 1000 according to a first embodiment of the present invention.

FIG. 2 shows an example of a digital filter used by an edge extraction unit 103 in the first embodiment.

FIGS. 3A to 3C are diagrams describing a color uneven area determination process performed by the display device 1000 of the first embodiment.

FIG. 4 is a flowchart showing processing performed by a color uneven area determination unit 104.

FIGS. 5A and 5B are diagrams describing the pixel positions of sub-pixels and the effect of each sub-pixel on the Y signal.

FIG. 6 is a flowchart showing processing performed by a color unevenness selective reduction unit 105.

FIGS. 7A to 7C are diagrams describing a color unevenness selective reduction process performed by the display device 1000 of the first embodiment.

FIGS. 8A to 8C are diagrams describing a color uneven area determination process performed by an apparatus according to a first modification of the first embodiment.

FIGS. 9A to 9C are diagrams describing a color unevenness selective reduction process performed by the apparatus of the first modification of the first embodiment.

FIGS. 10A to 10C are diagrams describing a color unevenness selective reduction process performed by an apparatus according to a second modification of the first embodiment.

FIGS. 11A and 11B are diagrams describing an arrangement of sub-pixels of a display device, the corresponding data sequence, and the structure of a pixel that is composed of sub-pixels.

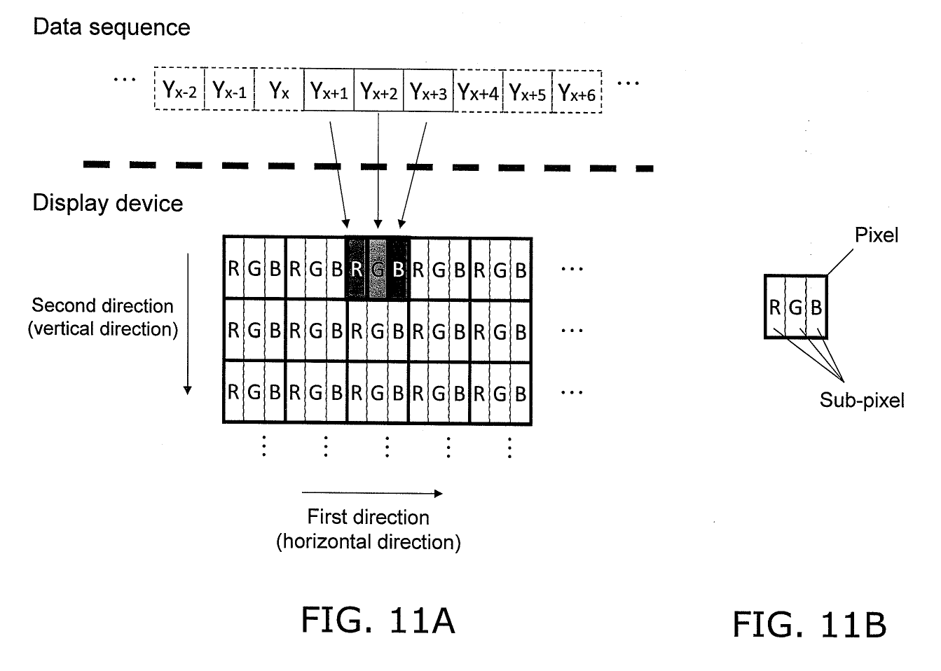

### EXPLANATION OF REFERENCE

1000 display device
100 signal processing unit (image processing apparatus)
101 sub-pixel precision image obtaining unit
102 color conversion unit
103 edge extraction unit
104 color uneven area determination unit
105 color unevenness selective reduction unit
106 sub-pixel mapping unit
110 display device

### BEST MODE FOR CARRYING OUT THE INVENTION

An embodiment of the present invention will now be described with reference to the drawings.

### First Embodiment

### 1.1 Structure of the Display Device

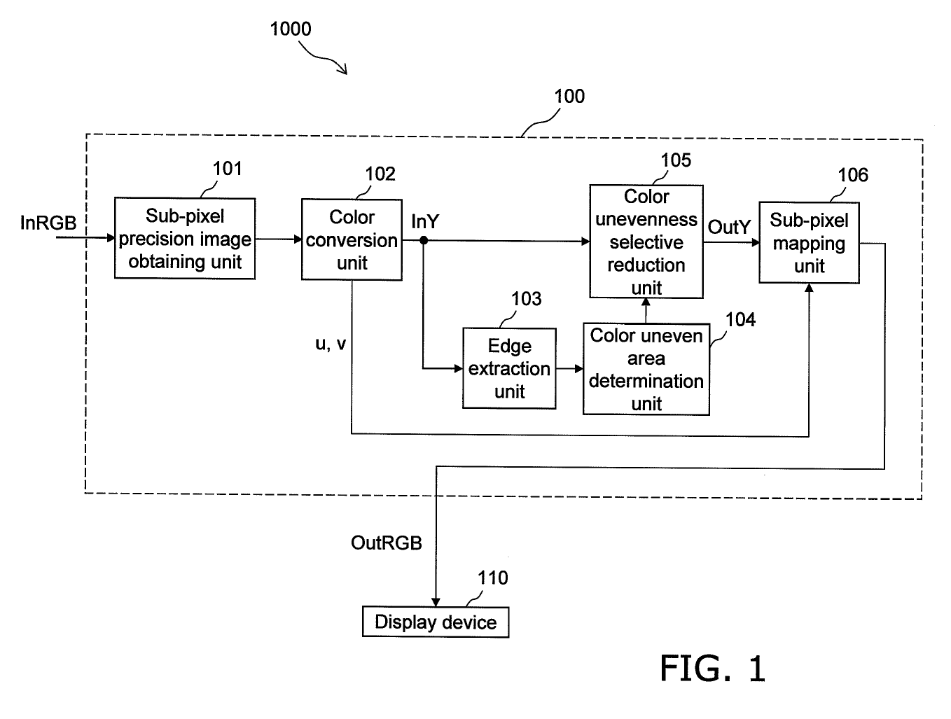

FIG. 1 is a block diagram of a display device 1000 according to a first embodiment of the present invention.

The display device 1000 includes a signal processing unit 100 and a display device 110. The signal processing unit 100 processes an input signal, and outputs the resulting signal to the display device 110. The display device 110 displays red, green, and blue (RGB) data output from the signal processing unit 100.

The signal processing unit 100 includes a sub-pixel precision image obtaining unit 101 and a color conversion unit 102. The sub-pixel precision image obtaining unit 101 obtains an image having a sub-pixel precision, which is a precision determined by the number of light emitting units (sub-pixels). The color conversion unit 102 converts a video (image) signal defined in the RGB color space, which is output from the sub-pixel precision image obtaining unit 101, to a signal defined in the YUV color space, which consists of brightness information (an InY signal) and chromaticity information (a U signal and a V signal). The signal processing unit 100 includes an edge extraction unit 103 and a color uneven area determination unit 104. The edge extraction unit 103 extracts edge information from image data (video (image) signal) having a sub-pixel precision. The color uneven area determination unit 104 determines an image area in which color unevenness occurs based on the edge information extracted by the edge extraction unit 103. The signal processing unit 100 further includes a color unevenness selective reduction unit 105 and a sub-pixel mapping unit 106. The color unevenness selective reduction unit 105 processes an InY signal output from the color conversion unit 102 through color unevenness selective reduction processing. The sub-pixel mapping unit 106 generates data (video (image) signal) (an OutRGB signal) for each of the sub-pixels of red (R), green (G), and blue (B) based on brightness information (an OutY signal) output from the color unevenness selective reduction unit 105 and a U signal and a V signal output from the color conversion unit 102.

The display device 110 receives an OutRGB signal output from the signal processing unit 100, and displays a video (image) that is formed using the OutRGB signal.

Each component of the display device 1000 will now be described in more detail.

The sub-pixel precision image obtaining unit 101 obtains an image (image signal) having a sub-pixel precision, which a precision equivalent to the number of light emitting units (sub-pixels). For ease of explanation, the number of light emitting units in the present embodiment is three times the number of display pixels in a horizontal direction of a display screen (image formed using an image signal). The sub-pixel precision image obtaining unit 101 obtains a video (image) signal having image data three times the display pixels in the horizontal direction of the display screen. For example, when the display screen has X pixels per line (in the horizontal direction), the sub-pixel precision image obtaining unit 101 obtains a video (image) signal having image data corresponding to 3X pixels as a video (image) signal forming one line.

The color conversion unit 102 converts an input video (image) signal defined in the RGB color space to a video (image) signal defined in the YUV color space. More specifically, the color conversion unit 102 receives a video (image) signal in the RGB color space output from the sub-pixel precision image obtaining unit 101, and converts the input video (image) signal in the RGB color space to a signal indicating brightness information (an InY signal) and signals indicating chromaticity information (a U signal and a V signal).

In the present embodiment, both the signals input into and output from the signal processing unit 100 are defined in the RGB color space, whereas the internal processing of the signal processing unit 100 is performed using the YUV color space. Alternatively, brightness information used in the internal processing of the signal processing unit 100 may be brightness information defined in other color spaces, such as brightness information (Y) in the YCbCr color space and brightness information (L) in the Lab color space. When the color space conversion is not necessary, the color conversion unit 102 can be eliminated. Conversion equations known in the art may be used by the color conversion unit 102. The color conversion is not essential to the present invention, and thus will not be described in detail.

The arrangement of the sub-pixel precision image obtaining unit 101 and the color conversion unit 102 should not be limited to the arrangement shown in FIG. 1. The sub-pixel precision image obtaining unit 101 may be arranged downstream from the color conversion unit 102. When the display device is implemented by hardware, the above arrangement, which only requires the sub-pixel precision image obtaining unit 101 to perform interpolation for the brightness signal, downsizes the circuit scale of the apparatus.

The edge extraction unit 103 receives an InY signal output from the color conversion unit 102, and extracts edge information from image data having a sub-pixel precision based on the InY signal. The edge extraction unit 103 performs, for example, filtering using a high-pass filter to extract edge information from the InY signal having a sub-pixel precision. The edge extraction unit 103 outputs the extracted edge information to the color uneven area determination unit 104.

The color uneven area determination unit 104 receives edge information extracted by the edge extraction unit 103. Based on the edge information extracted by the edge extraction unit 103, the color uneven area determination unit 104 determines an image area in which color unevenness occurs in an image formed using the InY signal. The color uneven area determination unit 104 then outputs, to the color unevenness selective reduction unit 105, information about the image area in which color unevenness occurs.

The color unevenness selective reduction unit 105 receives an InY signal, which is output from the color conversion unit 102, and information about the image area in which color unevenness occurs, which is output from the color uneven area determination unit 104. Based on the information about the color uneven area output from the color uneven area determination unit 104, the color unevenness selective reduction unit 105 processes the InY signal through processing for selectively reducing color unevenness in the color uneven area. The color unevenness selective reduction unit 105 then outputs, as an OutY signal, the processed InY signal to the sub-pixel mapping unit 106.

The sub-pixel mapping unit 106 receives an OutY signal, which is output from the color unevenness selective reduction unit 105, and a U signal and a V signal, which are output from the color conversion unit 102, and generates an OutRGB signal based on the OutY signal and the U and V signals and outputs the OutRGB signal to the display device 110. More specifically, the sub-pixel mapping unit 106 converts the OutY signal and the U and V signals, which are video (image) signals in the YUV color space, through the YUV to RGB color space conversion to generate an OutRGB signal, which is a video (image) signal in the RGB color space. The sub-pixel mapping unit 106 then outputs the video (image) signal resulting from the color space conversion, or specifically the OutRGB signal, to the display device 110.

The display device 110 receives an OutRGB signal output from the sub-pixel mapping unit 106, and displays a video (image) that is formed using the OutRGB signal on the display screen of the display device 110. Each pixel on the display screen of the display device 110, which may for example be a color LDC or a color plasma display, is composed of a plurality of light emitting unit. In the present embodiment, each pixel of the display device 110 is composed of three light emitting units respectively emitting three primary colors, RGB. The light emitting units are arranged on the display screen of the display device 110 in the order of R, G, and B in the horizontal direction (line direction) of the display screen. The arrangement order of the light emitting units of the display device 110 should not be limited to the above order of R, G, and B in the horizontal direction (line direction) of the display screen of the display device 110. For example, the light emitting units may be arranged in the order of B, R, and G in the horizontal direction (line direction) of the display screen of the display device 110, or may be arranged in other orders.

The signal processing unit 100 of the present embodiment functions as an image processing apparatus.

### 1.2 Operation of the Display Device

The operation of the display device 1000 with the above-described structure will now be described.

An InRGB signal, which is a video (image) signal having a pixel precision, is converted to a video signal having a sub-pixel precision by the sub-pixel precision image obtaining unit 101. The resulting signal is then output to the color conversion unit 102. The InRGB signal is a video signal defined in the RGB color space.

In the present embodiment, an image having a sub-pixel precision (three-times data) (video (image) signal having a sub-pixel precision) is obtained by interpolation performed using an image having a pixel precision (video (image) signal having a pixel precision). The interpolation may be performed with a typical interpolation technique, and preferably be performed with an interpolation technique of estimating, with a higher precision, information corresponding to high-frequency components of a video (image) formed using a video (image) signal.

The processing performed by the sub-pixel precision image obtaining unit 101 may be performed with a technique of directly generating three-times data using, for example, a graphics engine. Such a technique is disclosed in Japanese Unexamined Patent Publication No. 2005-128173. Alternatively, the processing performed by the sub-pixel precision image obtaining unit 101 may be performed with a technique of obtaining three-times data when reducing an image larger than the display size to the display size and displaying the reduced image. Such a technique is disclosed in Japanese Unexamined Patent Publication No. 2002-40985. This technique enables high-frequency components of data to be used more effectively than the technique of generating high-frequency components of a video (image) formed using a video (image) signal by interpolation, and thus enables a video (image) with a higher resolution (video (image) having a sub-pixel precision) to be obtained.

The video signal having a sub-pixel precision obtained by the sub-pixel precision image obtaining unit 101 is then processed through the RGB to YUV color space conversion by the color conversion unit 102. The InY signal, which is a video signal containing brightness information resulting from the RGB to YUV color space conversion, is output to the edge extraction unit 103 and the color unevenness selective reduction unit 105. The U and V signals, which are video signals containing chromaticity information resulting from the RGB to YUV color space conversion, are output to the sub-pixel mapping unit 106.

The edge extraction unit 103 extracts edge information from the input InY signal.

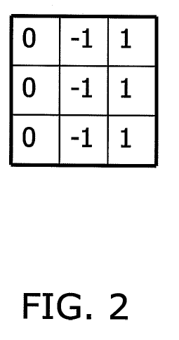

In one example, it is preferable to extract edge information from the InY signal by filtering using a digital filter having 3*3 pixels shown in FIG. 2. In FIG. 2, the numeral in the center indicates a weighting coefficient used for a target sub-pixel (a processing target sub-pixel), and the eight numerals surrounding the central numeral indicate weighting coefficients for eight neighboring sub-pixels that are adjacent to the target sub-pixel. The digital filter is used to perform weighted averaging on the target sub-pixel and the neighboring sub-pixels.

The InY signal is filtered using this digital filter. When an edge (edge in a video (image) formed using the InY signal) is between a target sub-pixel (processing target sub-pixel) and a sub-pixel adjacent to the target sub-pixel on the right, a large value (absolute value) is output from the digital filter. When no edge is between these sub-pixels, a small value is output from the digital filter.

Based on the output value of the digital filter, the edge extraction unit 103 determines the position of an edge in the video (image) formed using the InY signal. More specifically, when the absolute value of the output value of the digital filter exceeds a threshold, the edge extraction unit 103 determines that the target sub-pixel (the processing target InY signal) corresponds to an edge (the target sub-pixel is included in an edge area). In this example, the threshold may be 32 (when the brightness information InY (InY signal) has eight bits). The threshold may be another value, or may be variable.

The digital filter shown in FIG. 2 is a mere example. Another digital filter may be used. A one-dimensional digital filter may be used. Any digital filter that can be used to determine the position of an edge in a direction in which sub-pixels are arranged (a horizontal direction when sub-pixels are arranged both in a horizontal direction (line direction) and in a vertical direction) may be used.

The edge information extracted by the edge extraction unit 103 in the above manner is then output to the color uneven area determination unit 104.

The color uneven area determination unit 104 determines a color uneven area based on the edge information extracted by the edge extraction unit 103. In detail, the color uneven area determination unit 104 determines a color uneven area based on the relationship between the position of an edge (position on the image) that is identified by the edge information extracted by the edge extraction unit 103 and the position of a sub-pixel for the B component. In more detail, the color uneven area determination unit 104 determines, as a color uneven area, an area in which the second sub-pixel from the position of the edge is a sub-pixel for the B component.

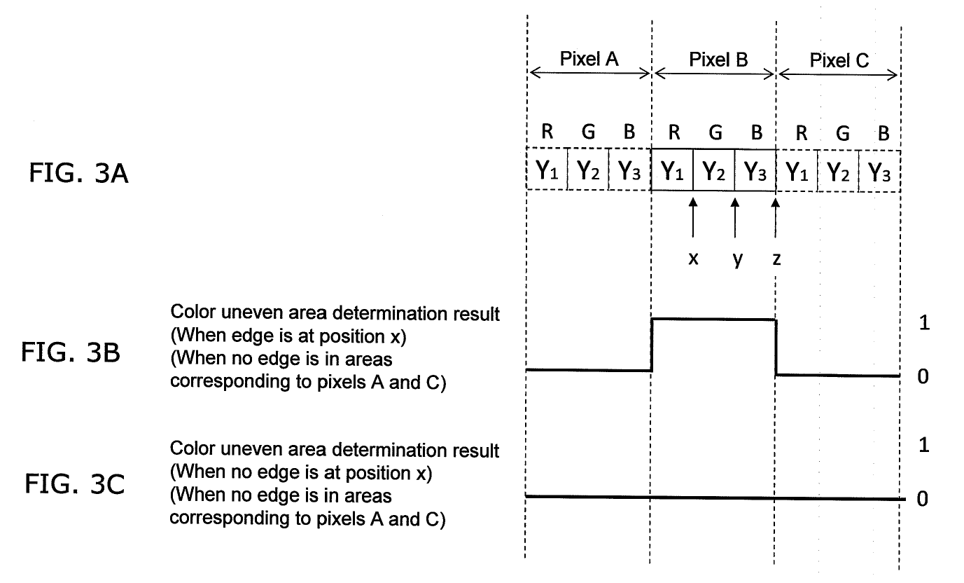

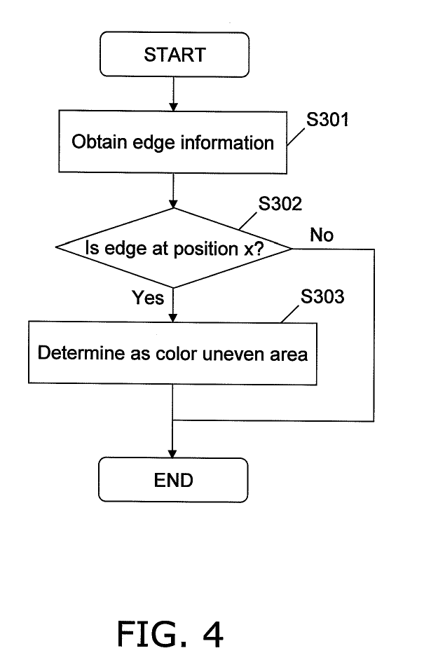

The processing described above will now be described with reference to FIGS. 3A to 3C and FIG. 4. In the present embodiment, a color uneven area is determined in units of three sub-pixels that form one pixel.

FIG. 3A shows three sub-pixels (three sub-pixels forming a pixel B), which are processing target sub-pixels, and pixels (pixels A and C) adjacent to the target sub-pixels. FIGS. 3B and 3C show color unevenness determination results corresponding to the sub-pixels of the pixels A to C. The areas corresponding to the pixels A and C shown in FIGS. 3A to 3C include no edge.

In FIG. 3A, Y indicates brightness information, with numerical subscripts 1, 2, and 3 indicating one of the R, G, and B sub-pixels for which the brightness information is mapped by the sub-pixel mapping unit 106, which will be described later.

When, for example, one pixel of the display device consists of three sub-pixels arranged in the order of R, G, and B, Y1 indicates brightness information for the R component sub-pixel, Y2 indicates brightness information for the G component sub-pixel, and Y3 indicates brightness information for the B component sub-pixel.

Rectangles drawn with a dotted line in the figure indicate brightness information corresponding to three sub-pixels adjacent to the target three sub-pixels on the right and on the left.

FIG. 4 is a flowchart showing the processing performed by the color uneven area determination unit 104.

The color uneven area determination unit 104 refers to an edge position determined by the edge extraction unit 103 (step S301), and determines whether an edge is at position x in FIG. 3A (step S302). When determining that an edge is at position x in FIG. 3A, the color uneven area determination unit 104 determines that an area corresponding to three sub-pixels forming the pixel B is a color uneven area (step S303). In any other cases, that is, when an edge is at position y or position z, or no edge is at any position, the color uneven area determination unit 104 determines that the area corresponding to the three sub-pixels forming the pixel B is not a color uneven area.

In FIG. 3B, an edge is at position x and no edge is in areas corresponding to the pixels A and C. In this case, the color uneven area determination unit 104 determines that only the area corresponding to the pixel B (in other words, the area corresponding to the three sub-pixels forming the pixel B) is a color uneven area. In FIGS. 3B and 3C, the values of 0 and 1 on the vertical axis each indicate a color uneven area determination result. The value of 0 indicates that the area has not been determined as a color uneven area, whereas the value of 1 indicates that the area has been determined as a color uneven area.

In FIG. 3C, no edge is at position x (that is, an edge is at position y or position z, or no edge is in the area corresponding to the pixel B). In this case, the color uneven area determination unit 104 determines that the area corresponding to the pixel B (the area corresponding to three pixels forming the pixel B) is not a color uneven area.

The color uneven area determination unit 104 determines a color uneven area in the manner described above.

Although the present embodiment describes the signal processing performed when the display device includes sub-pixels arranged in the order of R, G and B in the horizontal direction (line direction), the arrangement order of the sub-pixels of the display device should not be limited to the order of R, G, and B. The sub-pixels of the display device may be arranged in any other order but it is only required that the color uneven area determination unit 104 can determine that an area having a data pattern in which the second sub-pixel from an edge is a sub-pixel for the B component is a color uneven area.

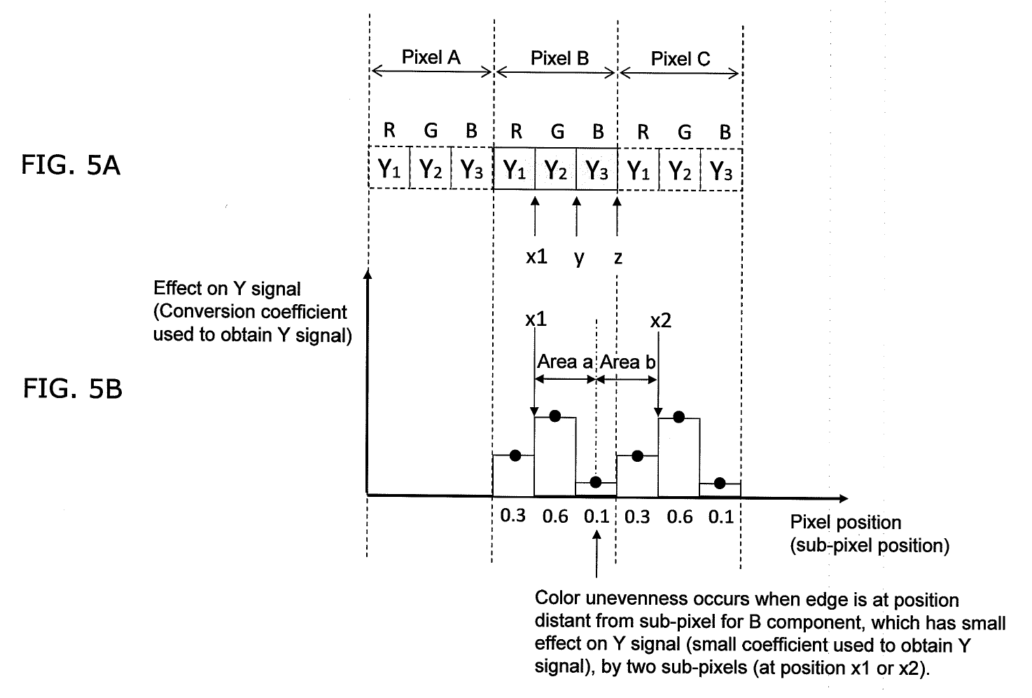

Color unevenness will now be described with reference to FIGS. 5A and 5B.

FIG. 5A shows the positional relationship between the pixels A to C and their sub-pixels. FIG. 5B shows the relationship between the pixel positions (sub-pixel positions) of the sub-pixels included in the pixels A to C in FIG. 5A and the effect of these sub-pixels on the Y signal (conversion coefficients used in conversion to the Y signal).

When conversion is performed from the RGB color space to the YUV color space, the Y signal, which corresponds to brightness (brightness signal), and the U signal and the V signal, which are color signals, are obtained based on the R, G, and B signals using the equations below:

Y=0.299R+0.587G+0.114B,

U=(B−Y)/2.03=−0.147R−0.289G+0.436B, and

V=(R−Y)/1.14=0.615R−0.515G−0.100B.

In the above conversion equation for the Y signal, the R signal is multiplied by a coefficient of 0.299, the G signal by a coefficient of 0.587, and the B signal by a coefficient of 0.114. Thus, the R, G, and B signals each have a different contribution to (or effect on) the Y signal (the G signal is multiplied by the largest coefficient, meaning that the G signal has the largest contribution to (or effect on) the Y signal).

For ease of explanation, the multiplier coefficients (multiplier coefficients used in the equation to obtain the Y signal) in FIG. 5B are round off to the first decimal place.

As shown in FIG. 5B, the B component has a small effect of 0.1 on the Y signal. Thus, when an edge is at position x1 or position x2 in FIG. 5B (at a position that is distant from a sub-pixel for the B component by two sub-pixels), color unevenness is highly likely to occur. The inventors of the present application have found this through experiments. When a sub-pixel for the B component, which has a small effect on the Y signal, is at a position that is distant from an edge by two sub-pixels, areas that are at the two sides of the sub-pixel for the B component are perceived as separate areas due to human visual perception. More specifically, when an edge is at position x1 or position x2 and a sub-pixel for the B component is at a position that is distant from the edge by two sub-pixels as shown in FIG. 5B, humans will perceive areas a and b as separate areas.

Based on this, the color uneven area determination unit 104 determines a color uneven area based on whether a sub-pixel for the B component is at a position that is distant from an edge by two sub-pixels.

The color uneven area determination unit 104 determines a color uneven area in this manner, and outputs information about the determined color uneven area to the color unevenness selective reduction unit 105.

The color unevenness selective reduction unit 105 processes an InY signal output from the color conversion unit 102 through color unevenness selective reduction processing based on the information about the color uneven area determined by the color uneven area determination unit 104.

The color unevenness selective reduction processing performed by the color unevenness selective reduction unit 105 will now be described.

The color unevenness selective reduction unit 105 performs different color unevenness selective reduction processing on an area that has been determined as a color uneven area by the color uneven area determination unit 104. More specifically, the color unevenness selective reduction unit 105 performs color unevenness selective reduction processing that reduces color unevenness more (or that produces a stronger effect) on an area that has been determined as a color uneven area by the color uneven area determination unit 104 than on an area that has not been determined as a color uneven area by the color uneven area determination unit 104.

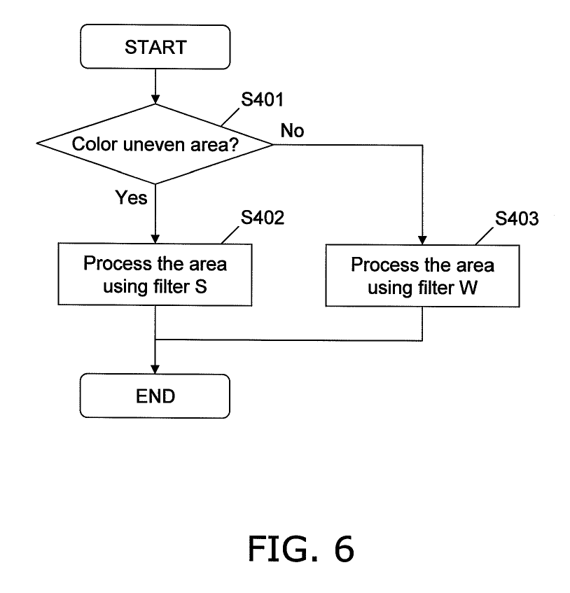

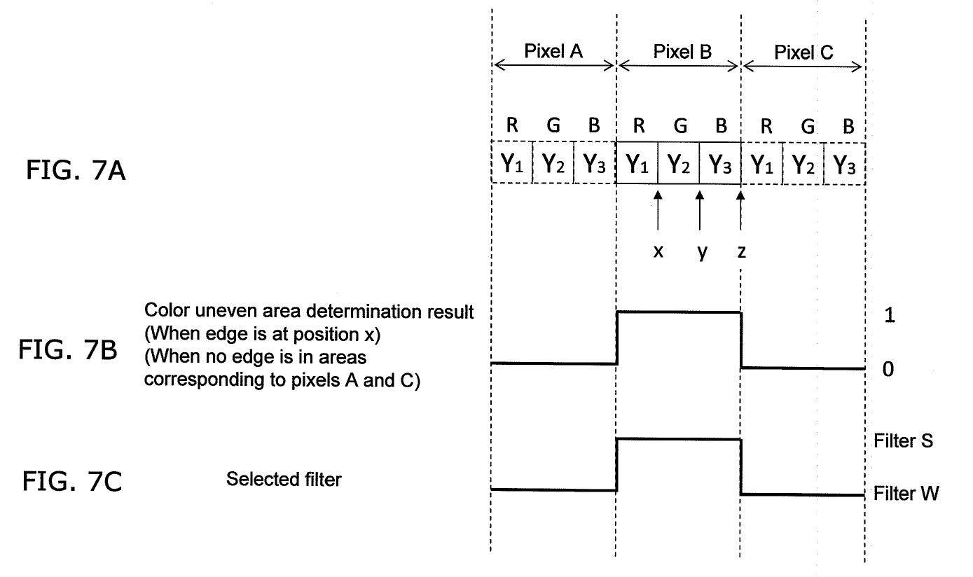

The processing performed by the color unevenness selective reduction unit 105 will now be described with reference to FIG. 6 and FIGS. 7A to 7C.

FIG. 6 is a flowchart showing the color unevenness selective reduction processing performed by the color unevenness selective reduction unit 105.

The color unevenness selective reduction unit 105 first determines whether an area corresponding to a processing target sub-pixel (an InY signal corresponding to the target sub-pixel) is a color uneven area based on information about a color uneven area output from the color uneven area determination unit 104 (step S401). The color unevenness selective reduction unit 105 processes an area that has been determined as a color uneven area in step S401 through filtering using a filter S, which reduces color unevenness more (or which produces a stronger color unevenness reducing effect) (step S402). The color unevenness selective reduction unit 105 processes an area that has not been determined as a color uneven area in step S401 through filtering using a filter W, which reduces color unevenness less (or which produces a weaker color unevenness reducing effect) (step S403).

In one example, sampling in units of sub-pixels may be performed with a Nyquist frequency of 1.0. In this case, the filter S may for example be a low-pass filter having a cut-off frequency of 0.25, whereas the filter W may for example be a low-pass filter having a cut-off frequency of 0.35.

The filters S and W described above are mere examples. The filters S and W may be any two filters, but it is only required that the filter S, which is used to process a color uneven area, have a lower cut-off frequency than the filter W. It is preferable that the filter S be formed using a low-pass filter having a cut-off frequency lower than 0.33, and the filter W be formed using a low-pass filter having a cut-off frequency higher than 0.33. With the cut-off frequencies of the filters S and W set in this manner, the filter S reduces color unevenness more (produces a stronger smoothing effect), whereas the filter W reduces color unevenness less (produces a weaker smoothing effect).

With the processing using the filters S and W described above, the display device 1000 maintains high-frequency components of the InY signal in an area in which color unevenness is unnoticeable, and thus forms a video (image) without losing high-frequency components in a precision higher than the pixel precision. The video (image) formed by the display device 1000 is displayed in a manner that its high-frequency components are rendered in an appropriate manner in a precision higher than the pixel precision. The display device 1000, which performs the processing using the filters S and W, processes an area in which color unevenness is noticeable using the filter S that reduces color unevenness more (produces a stronger smoothing effect), and thus obtains a video (image) in which color unevenness is reduced sufficiently.

The filter selection performed by the color unevenness selective reduction unit 105 will now be described in more detail with reference to FIGS. 7A to 7C.

FIG. 7A shows the positional relationship between the pixels A to C and their sub-pixels. FIG. 7B shows color unevenness determination results corresponding to the sub-pixels forming the pixels A to C. FIG. 7C shows the filter selection performed by the color unevenness selective reduction unit 105 corresponding to the color unevenness determination results shown in FIG. 7B. FIG. 7B shows the determination results when an edge is at position x and no edge is in areas corresponding to the pixels A and C. In this case, the color unevenness selective reduction unit 105 selects the filter in the manner shown in FIG. 7C. More specifically, the color unevenness selective reduction unit 105 selects the filter S that produces a stronger color unevenness reducing effect for the area corresponding to the pixel B, which is a color uneven area, whereas the color unevenness selective reduction unit 105 selects the filter W that produces a weaker color unevenness reducing effect for the areas corresponding to the pixels A and C, which are not color uneven areas.

The above processing performed by the color unevenness selective reduction unit 105 enables a color uneven area to reduce its color unevenness, and an area that is not a color uneven area to maintain its high-frequency components.

Although the present embodiment describes the case in which areas that are not color uneven areas are also processed through filtering (using the filter W), the present invention should not be limited to this method. For example, areas that are not color uneven areas may not be processed through filtering (in other words, the input signal is directly output for such areas).

The InY signal processed by the color unevenness selective reduction unit 105 through the color unevenness selective reduction processing described above is then output as an OutY signal to the sub-pixel mapping unit 106.

The sub-pixel mapping unit 106 generates data for each of the R, and B sub-pixels based on the brightness information having a sub-pixel precision (OutY signal) output from the color unevenness selective reduction unit 105 and the chromaticity information having a sub-pixel precision (a U signal and a V signal) output from the color conversion unit 102. More specifically, the sub-pixel mapping unit 106 converts the OutY signal, the U signal, and the V signal, which are video (image) signals defined in the YUV color space, to an OutRGB signal, which is a video (image) signal defined in the RGB color space through the YUV to RGB color space conversion. The OutRGB signal obtained by the sub-pixel mapping unit 106 through the YUV to RGB color space conversion is then output to the display device 110.

The YUV to RGB color space conversion may be performed with any method known in the art, or may be performed with a method described, for example, in Japanese Patent No. 3476787.

The OutRGB signal output from the sub-pixel mapping unit 106 is displayed by the display device 110 as a video (image) on its display screen.

As described above, the display device 1000 processes only an area (image area) in which color unevenness is noticeable using the filter that produces a strong effect (filter that produces a strong color unevenness reducing effect), and thus enables other areas to maintain a high perceived resolution. As a result, the display device 1000 displays a video (image) with a high perceived resolution while reducing color unevenness in the video (image).

### First Modification

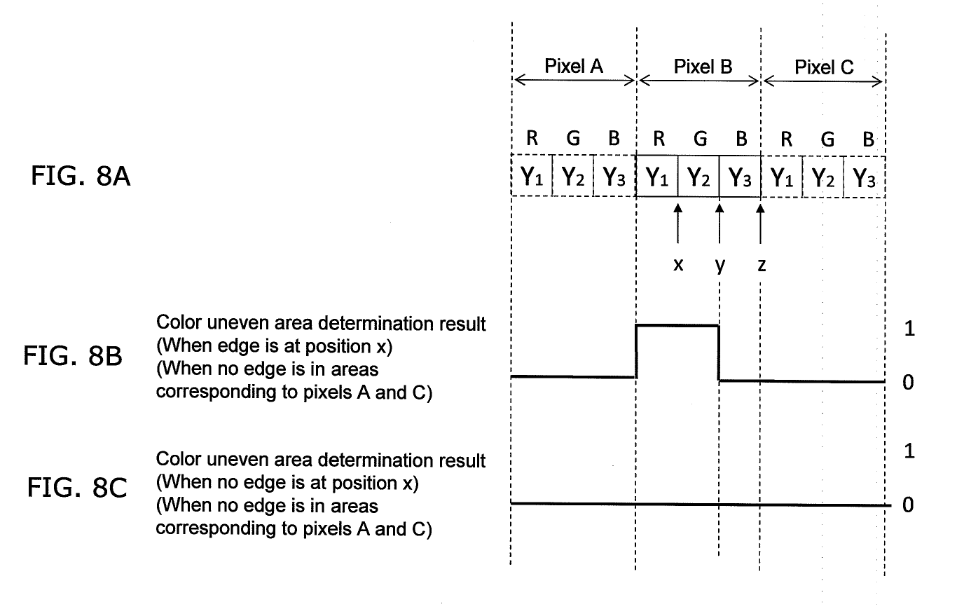

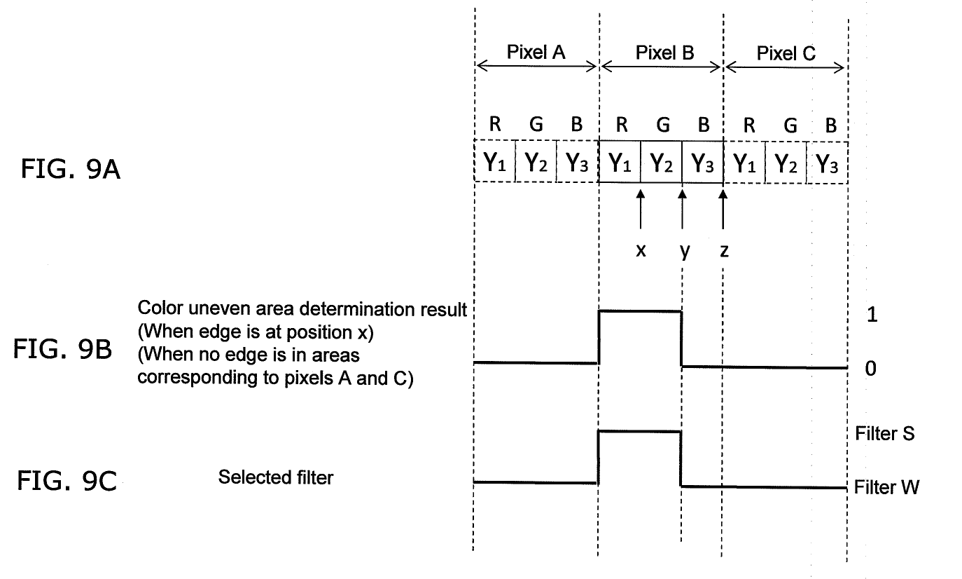

A first modification of the present embodiment will now be described with reference to FIGS. 8A to 8C and FIGS. 9A to 9C.

The first modification differs from the first embodiment in that an area determined by a color uneven area determination unit 104 as a color uneven area is an area corresponding to two sub-pixels, and a color unevenness selective reduction unit 105 performs processing different from the processing described in the first embodiment.

FIG. 8A shows three processing target sub-pixels (three sub-pixels forming the pixel B) and pixels adjacent to the processing target sub-pixels (pixels A and C). FIGS. 8B and 8C show color unevenness determination results corresponding to the sub-pixels of the pixels A to C. FIGS. 8A to 8C show the determination results when no edge is included in the areas corresponding to the pixels A and C. FIGS. 9A to 9C show the positional relationship between the pixels A to C, the color unevenness area determination results obtained by the color uneven area determination unit 104, and the filter selection performed by the color unevenness selective reduction unit 105.

In FIG. 8B, an edge is at position x and no edge is in the areas corresponding to the pixels A and C. In this case, the color uneven area determination unit 104 determines an area corresponding to sub-pixels Y1 and Y2 of the pixel B (an area corresponding to the two sub-pixels surrounding the edge) as a color uneven area.

In FIG. 8C, no edge is at position x and no edge is in the areas corresponding to the pixels A and C. In this case, the color uneven area determination unit 104 determines that none of the areas corresponding to the pixels A to C is a color uneven area.

The color unevenness selective reduction unit 105 selects the filter S that produces a stronger color unevenness reducing effect for the area corresponding to the sub-pixels Y1 and Y2 of the pixel B, which has been determined as a color uneven area by the color uneven area determination unit 104, and selects the filter W that produces a weaker color unevenness reducing effect for the other areas as shown in FIGS. 9A to 9C, and performs the color unevenness selective reduction processing using the selected filters.

As described above, the first modification enables the color unevenness reduction processing to be performed selectively in smaller units of areas (image areas), and thus enables the color unevenness selective reduction processing to be performed with a still higher precision.

### Second Modification

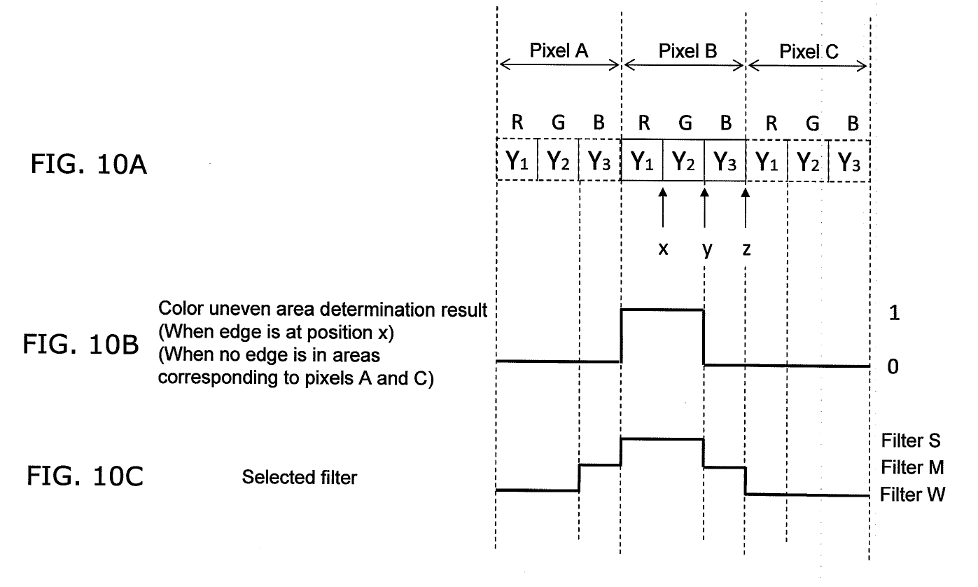

A second modification of the present embodiment will now be described with reference to FIGS. 10A to 10C.

The second modification differs from the first embodiment in that an area determined by a color uneven area determination unit 104 as a color uneven area is an area corresponding to two sub-pixels, and a color unevenness selective reduction unit 105 uses three different filters.

FIGS. 10A to 10C show the positional relationship between the pixels A to C, the color unevenness area determination results obtained by the color uneven area determination unit 104, and the filter selection performed by the color unevenness selective reduction unit 105.

In the second modification, the color unevenness selective reduction unit 105 has a filter M in addition to filters S and W. The filter M produces a color unevenness reducing effect intermediate between the effects produced by the filters S and W. More specifically, the filter M has a cut-off frequency intermediate between the cut-off frequencies of the filters S and W.

As shown in FIGS. 10A to 10C, the color unevenness selective reduction unit 105 in the second modification processes an area corresponding to sub-pixels Y1 and Y2, which has been determined as a color uneven area by the color uneven area determination unit 104 (area corresponding to two sub-pixels surrounding an edge), through filtering using the filter S that produces the strongest color unevenness reducing effect. The color unevenness selective reduction unit 105 processes an area corresponding to a sub-pixel Y3 of a pixel A, which is a sub-pixel adjacent to the color uneven area, and also an area corresponding to a sub-pixel Y3 of a pixel B, which is a sub-pixel adjacent to the color uneven area, through filtering using the filter M that produces the intermediate color unevenness reducing effect. The color unevenness selective reduction unit 105 processes other areas through filtering using the filter W with the weakest color unevenness reducing effect.

The filters used in the second modification enable the color unevenness reducing effect to change gradually. With such filters, the apparatus of the second modification performs the color unevenness reduction processing in a more appropriate manner without causing a drastic change between sub-pixels (or without side effects).

The filters used by the color unevenness selective reduction unit 105 should not be limited to the above three filters. The color unevenness selective reduction unit 105 may use four or more different filters to change the color unevenness reducing effect gradually.

Although the present modification describes the case in which an area corresponding to a single sub-pixel is used as an area adjacent to a color uneven area and is processed through filtering using the filter M, the present invention should not be limited to this method. An area corresponding to a plurality of sub-pixels adjacent to a color uneven area may be processed through filtering using the filter that produces the intermediate color unevenness reducing effect.

Although the present modification describes the case in which the color unevenness selective reduction unit 105 has the independent filters S, M and W, the present invention should not be limited to this method. For example, the color unevenness selective reduction unit 105 may use a variable filter coefficient to function as three (or a plurality of) different filters.

### Other Embodiments

Although the above embodiment describes the case in which the display device 1000 consistently processes an image in which sub-pixels are arranged in the order of R, G, and B, the present invention should not be limited to this structure. For example, the signal processing unit 100 included in the display device 1000 of the above embodiment may additionally include a display device switch IF unit, and may switch the processing performed by the signal processing unit 100 based on predetermined information input via the display device switch IF unit.

More specifically, when, for example, the display device 110 uses the RGB arrangement, the display device 1000 may receive a value of 0 input via the display device switch IF unit, and then switch the functional units of the signal processing unit 100 to perform processing for the RGB arrangement of the display device. When the display device 110 uses the BRG arrangement, the display device 1000 may receive a value of 1 input via the display device switch IF unit, and then switch the functional units of the signal processing unit 100 to perform processing for the BRG arrangement of the display device.

This structure enables the signal processing unit 100 to perform processing suitable for display devices that use various arrangement patterns.

Each block of the display device in the above embodiment may be formed using a single chip with a semiconductor device, such as LSI (large-scale integration), or some or all of the blocks of the display device may be formed using a single chip.

Although LSI is used as the semiconductor device technology, the technology may be IC (integrated circuit), system LSI, super LSI, or ultra LSI depending on the degree of integration of the circuit.

The circuit integration technology employed should not be limited to LSI, but the circuit integration may be achieved using a dedicated circuit or a general-purpose processor. A field programmable gate array (FPGA), which is an LSI circuit programmable after manufactured, or a reconfigurable processor, which is an LSI circuit in which internal circuit cells are reconfigurable or more specifically the internal circuit cells can be reconnected or reset, may be used.

Further, if any circuit integration technology that can replace LSI emerges as an advancement of the semiconductor technology or as a derivative of the semiconductor technology, the technology may be used to integrate the functional blocks of the display device. Biotechnology is potentially applicable.

The processes described in the above embodiment may be realized using either hardware or software, or may be realized using both software and hardware. When the display device of the above embodiment is implemented by hardware, the display device requires timing adjustment for each of its processes. For ease of explanation, timing adjustment associated with various signals required in an actual hardware design is not described in detail in the above embodiment.

The specific structures described in the above embodiment are mere examples of the present invention, and may be changed and modified variously without departing from the scope and spirit of the invention.

### INDUSTRIAL APPLICABILITY

The present invention is applicable to an image processing apparatus and an image processing method that improve image quality.

The image processing apparatus, the image processing method, the display device, the program, and the integrated circuit of the present invention enable color unevenness of video signals to be reduced effectively, and thus are useful and implementable in the audiovisual equipment industry.

1-12. (canceled)

13. An image processing apparatus for processing an image signal that is displayed on a display screen of a display device, the display screen being formed by arranging a plurality of pixels in a first direction to form a single line of the display screen and arranging a plurality of lines of the display screen in a second direction that is orthogonal to the first direction, each pixel including a sub-pixel for a red component, a sub-pixel for a green component, and a sub-pixel for a blue component, the apparatus comprising:
a sub-pixel precision image obtaining unit operable to obtain a sub-pixel precision image signal for forming a sub-pixel precision image having a sub-pixel precision, the sub-pixel precision being a precision corresponding to the number of sub-pixels;
an edge extraction unit operable to extract edge information from the sub-pixel precision image signal;
a color uneven area determination unit operable to determine a color uneven area based on the edge information, the color uneven area being an image area in which color unevenness occurs in the sub-pixel precision image; and
a color unevenness selective reduction unit operable to process the sub-pixel precision image signal through color unevenness selective reduction processing performed based on information about the color uneven area determined by the color uneven area determination unit,
wherein when an edge in the sub-pixel precision image extracted by the edge extraction unit is at a position that is distant from a sub-pixel for a blue component by two sub-pixels in the sub-pixel precision image, the color uneven area determination unit processes the sub-pixel precision image signal corresponding to an image area formed by a pixel including the sub-pixel for the blue component through color unevenness selective reduction processing that produces a first color unevenness reducing effect, and
when no edge in the sub-pixel precision image extracted by the edge extraction unit is at a position that is distant from a sub-pixel for a blue component by two sub-pixels in the sub-pixel precision image, the color uneven area determination unit processes the sub-pixel precision image signal corresponding to an image area formed by a pixel including the sub-pixel for the blue component through color unevenness selective reduction processing that produces a second color unevenness reducing effect weaker than the first color unevenness reducing effect.

14. An image processing apparatus for processing an image signal that is displayed on a display screen of a display device, the display screen being formed by arranging a plurality of pixels in a first direction to form a single line of the display screen and arranging a plurality of lines of the display screen in a second direction that is orthogonal to the first direction, each pixel including a sub-pixel for a red component, a sub-pixel for a green component, and a sub-pixel for a blue component, the apparatus comprising:
a sub-pixel precision image obtaining unit operable to obtain a sub-pixel precision image signal for forming a sub-pixel precision image having a sub-pixel precision, the sub-pixel precision being a precision corresponding to the number of sub-pixels;
an edge extraction unit operable to extract edge information from the sub-pixel precision image signal;
a color uneven area determination unit operable to determine a color uneven area based on the edge information, the color uneven area being an image area in which color unevenness occurs in the sub-pixel precision image; and
a color unevenness selective reduction unit operable to process the sub-pixel precision image signal through color unevenness selective reduction processing performed based on information about the color uneven area determined by the color uneven area determination unit,
wherein when an edge in the sub-pixel precision image extracted by the edge extraction unit is at a position that is distant from a sub-pixel for a blue component by two sub-pixels in the sub-pixel precision image, the color uneven area determination unit processes the sub-pixel precision image signal corresponding to an image area formed by two sub-pixels sandwiching the position of the edge in the sub-pixel precision image through color unevenness selective reduction processing that produces a first color unevenness reducing effect, and
when no edge in the sub-pixel precision image extracted by the edge extraction unit is at a position that is distant from a sub-pixel for a blue component by two sub-pixels in the sub-pixel precision image, the color uneven area determination unit processes the sub-pixel precision image signal corresponding to an image area formed by a pixel including the sub-pixel for the blue component through color unevenness selective reduction processing that produces a color unevenness reducing effect weaker than the first color unevenness reducing effect.

15. The image processing apparatus according to claim 14, wherein
when an edge in the sub-pixel precision image extracted by the edge extraction unit is at a position that is distant from a sub-pixel for a blue component by two sub-pixels in the sub-pixel precision image, the color uneven area determination unit processes the sub-pixel precision image signal corresponding to an edge part image area that is an image area formed by two sub-pixels sandwiching the position of the edge in the sub-pixel precision image through color unevenness selective reduction processing that produces a first color unevenness reducing effect, processes the sub-pixel precision image signal corresponding to an edge adjacent part image area that is an image area formed by at least one sub-pixel sandwiching the edge part image area in the sub-pixel precision image through color unevenness selective reduction processing that produces a second color unevenness reducing effect weaker than the first color unevenness reducing effect, and processes the sub-pixel precision image signal corresponding to an image area that is other than the edge part image area and the edge adjacent part image area in the sub-pixel precision image through color unevenness selective reduction processing that produces a third color unevenness reducing effect weaker than the second color unevenness reducing effect.

16. The image processing apparatus according to claim 13, further comprising:
a display device arrangement information input unit operable to receive input of information about an arrangement of sub-pixels of the display device.

17. A display device comprising:
the image processing apparatus according to claim 13; and
a display unit operable to display an image signal processed by the image processing apparatus.

18. An image processing method for processing an image signal that is displayed on a display screen of a display device, the display screen being formed by arranging a plurality of pixels in a first direction to form a single line of the display screen and arranging a plurality of lines of the display screen in a second direction that is orthogonal to the first direction, each pixel including a sub-pixel for a red component, a sub-pixel for a green component, and a sub-pixel for a blue component, the method comprising:
obtaining a sub-pixel precision image signal for forming a sub-pixel precision image having a sub-pixel precision, the sub-pixel precision being a precision corresponding to the number of sub-pixels;
extracting edge information from the sub-pixel precision image signal;
determining a color uneven area based on the edge information, the color uneven area being an image area in which color unevenness occurs in the sub-pixel precision image; and
processing the sub-pixel precision image signal through color unevenness selective reduction processing performed based on information about the color uneven area determined in the color uneven area determination step,
wherein when an edge in the sub-pixel precision image extracted by the edge extraction step is at a position that is distant from a sub-pixel for a blue component by two sub-pixels in the sub-pixel precision image, the sub-pixel precision image signal corresponding to an image area formed by a pixel including the sub-pixel for the blue component is processed through color unevenness selective reduction processing that produces a first color unevenness reducing effect in the color uneven area determination step, and
when no edge in the sub-pixel precision image extracted by the edge extraction step is at a position that is distant from a sub-pixel for a blue component by two sub-pixels in the sub-pixel precision image, the sub-pixel precision image signal corresponding to an image area formed by a pixel including the sub-pixel for the blue component is processed through color unevenness selective reduction processing that produces a second color unevenness reducing effect weaker than the first color unevenness reducing effect in the color uneven area determination step.

19. An image processing method for processing an image signal that is displayed on a display screen of a display device, the display screen being formed by arranging a plurality of pixels in a first direction to form a single line of the display screen and arranging a plurality of lines of the display screen in a second direction that is orthogonal to the first direction, each pixel including a sub-pixel for a red component, a sub-pixel for a green component, and a sub-pixel for a blue component, the method comprising:
obtaining a sub-pixel precision image signal for forming a sub-pixel precision image having a sub-pixel precision, the sub-pixel precision being a precision corresponding to the number of sub-pixels;
extracting edge information from the sub-pixel precision image signal;
determining a color uneven area based on the edge information, the color uneven area being an image area in which color unevenness occurs in the sub-pixel precision image; and
processing the sub-pixel precision image signal through color unevenness selective reduction processing performed based on information about the color uneven area determined in the color uneven area determination step,
wherein when an edge in the sub-pixel precision image extracted by the edge extraction step is at a position that is distant from a sub-pixel for a blue component by two sub-pixels in the sub-pixel precision image, the sub-pixel precision image signal corresponding to an image area formed by two sub-pixels sandwiching the position of the edge in the sub-pixel precision image is processed through color unevenness selective reduction processing that produces a first color unevenness reducing effect in the color uneven area determination step, and
when no edge in the sub-pixel precision image extracted by the edge extraction step is at a position that is distant from a sub-pixel for a blue component by two sub-pixels in the sub-pixel precision image, the sub-pixel precision image signal corresponding to an image area formed by a pixel including the sub-pixel for the blue component is processed through color unevenness selective reduction processing that produces a color unevenness reducing effect weaker than the first color unevenness reducing effect in the color uneven area determination step.

20. A program enabling a computer to implement an image processing method for processing an image signal that is displayed on a display screen of a display device, the display screen being formed by arranging a plurality of pixels in a first direction to form a single line of the display screen and arranging a plurality of lines of the display screen in a second direction that is orthogonal to the first direction, each pixel including a sub-pixel for a red component, a sub-pixel for a green component, and a sub-pixel for a blue component, the program enabling the computer to:
obtain a sub-pixel precision image signal for forming a sub-pixel precision image having a sub-pixel precision, the sub-pixel precision being a precision corresponding to the number of sub-pixels;
extract edge information from the sub-pixel precision image signal;
determine a color uneven area based on the edge information, the color uneven area being an image area in which color unevenness occurs in the sub-pixel precision image; and
process the sub-pixel precision image signal through color unevenness selective reduction processing performed based on information about the color uneven area determined in the color uneven area determination step,
wherein when an edge in the sub-pixel precision image extracted by the edge extraction step is at a position that is distant from a sub-pixel for a blue component by two sub-pixels in the sub-pixel precision image, the sub-pixel precision image signal corresponding to an image area formed by a pixel including the sub-pixel for the blue component is processed through color unevenness selective reduction processing that produces a first color unevenness reducing effect in the color uneven area determination step, and
when no edge in the sub-pixel precision image extracted by the edge extraction step is at a position that is distant from a sub-pixel for a blue component by two sub-pixels in the sub-pixel precision image, the sub-pixel precision image signal corresponding to an image area formed by a pixel including the sub-pixel for the blue component is processed through color unevenness selective reduction processing that produces a second color unevenness reducing effect weaker than the first color unevenness reducing effect in the color uneven area determination step.

21. A program enabling a computer to implement an image processing method for processing an image signal that is displayed on a display screen of a display device, the display screen being formed by arranging a plurality of pixels in a first direction to form a single line of the display screen and arranging a plurality of lines of the display screen in a second direction that is orthogonal to the first direction, each pixel including a sub-pixel for a red component, a sub-pixel for a green component, and a sub-pixel for a blue component, the program enabling the computer to:
obtain a sub-pixel precision image signal for forming a sub-pixel precision image having a sub-pixel precision, the sub-pixel precision being a precision corresponding to the number of sub-pixels;
extract edge information from the sub-pixel precision image signal;
determine a color uneven area based on the edge information, the color uneven area being an image area in which color unevenness occurs in the sub-pixel precision image; and
process the sub-pixel precision image signal through color unevenness selective reduction processing performed based on information about the color uneven area determined in the color uneven area determination step,
wherein when an edge in the sub-pixel precision image extracted by the edge extraction step is at a position that is distant from a sub-pixel for a blue component by two sub-pixels in the sub-pixel precision image, the sub-pixel precision image signal corresponding to an image area formed by two sub-pixels sandwiching the position of the edge in the sub-pixel precision image is processed through color unevenness selective reduction processing that produces a first color unevenness reducing effect in the color uneven area determination step, and
when no edge in the sub-pixel precision image extracted by the edge extraction step is at a position that is distant from a sub-pixel for a blue component by two sub-pixels in the sub-pixel precision image, the sub-pixel precision image signal corresponding to an image area formed by a pixel including the sub-pixel for the blue component is processed through color unevenness selective reduction processing that produces a color unevenness reducing effect weaker than the first color unevenness reducing effect in the color uneven area determination step.

22. An integrated circuit for processing an image signal that is displayed on a display screen of a display device, the display screen being formed by arranging a plurality of pixels in a first direction to form a single line of the display screen and arranging a plurality of lines of the display screen in a second direction that is orthogonal to the first direction, each pixel including a sub-pixel for a red component, a sub-pixel for a green component, and a sub-pixel for a blue component, the integrated circuit comprising:
a sub-pixel precision image obtaining unit operable to obtain a sub-pixel precision image signal for forming a sub-pixel precision image having a sub-pixel precision, the sub-pixel precision being a precision corresponding to the number of sub-pixels;
an edge extraction unit operable to extract edge information from the sub-pixel precision image signal;
a color uneven area determination unit operable to determine a color uneven area based on the edge information, the color uneven area being an image area in which color unevenness occurs in the sub-pixel precision image; and
a color unevenness selective reduction unit operable to process the sub-pixel precision image signal through color unevenness selective reduction processing performed based on information about the color uneven area determined by the color uneven area determination unit,
wherein when an edge in the sub-pixel precision image extracted by the edge extraction unit is at a position that is distant from a sub-pixel for a blue component by two sub-pixels in the sub-pixel precision image, the color uneven area determination unit processes the sub-pixel precision image signal corresponding to an image area formed by a pixel including the sub-pixel for the blue component through color unevenness selective reduction processing that produces a first color unevenness reducing effect, and
when no edge in the sub-pixel precision image extracted by the edge extraction unit is at a position that is distant from a sub-pixel for a blue component by two sub-pixels in the sub-pixel precision image, the color uneven area determination unit processes the sub-pixel precision image signal corresponding to an image area formed by a pixel including the sub-pixel for the blue component through color unevenness selective reduction processing that produces a second color unevenness reducing effect weaker than the first color unevenness reducing effect.

23. An integrated circuit for processing an image signal that is displayed on a display screen of a display device, the display screen being formed by arranging a plurality of pixels in a first direction to form a single line of the display screen and arranging a plurality of lines of the display screen in a second direction that is orthogonal to the first direction, each pixel including a sub-pixel for a red component, a sub-pixel for a green component, and a sub-pixel for a blue component, the integrated circuit comprising:
a sub-pixel precision image obtaining unit operable to obtain a sub-pixel precision image signal for forming a sub-pixel precision image having a sub-pixel precision, the sub-pixel precision being a precision corresponding to the number of sub-pixels;
an edge extraction unit operable to extract edge information from the sub-pixel precision image signal;
a color uneven area determination unit operable to determine a color uneven area based on the edge information, the color uneven area being an image area in which color unevenness occurs in the sub-pixel precision image; and
a color unevenness selective reduction unit operable to process the sub-pixel precision image signal through color unevenness selective reduction processing performed based on information about the color uneven area determined by the color uneven area determination unit,
wherein when an edge in the sub-pixel precision image extracted by the edge extraction unit is at a position that is distant from a sub-pixel for a blue component by two sub-pixels in the sub-pixel precision image, the color uneven area determination unit processes the sub-pixel precision image signal corresponding to an image area formed by two sub-pixels sandwiching the position of the edge in the sub-pixel precision image through color unevenness selective reduction processing that produces a first color unevenness reducing effect, and
when no edge in the sub-pixel precision image extracted by the edge extraction unit is at a position that is distant from a sub-pixel for a blue component by two sub-pixels in the sub-pixel precision image, the color uneven area determination unit processes the sub-pixel precision image signal corresponding to an image area formed by a pixel including the sub-pixel for the blue component through color unevenness selective reduction processing that produces a color unevenness reducing effect weaker than the first color unevenness reducing effect.

24. The integrated circuit according to claim 22, further comprising:
a display device arrangement information input unit operable to receive input of information about an arrangement of sub-pixels of the display device.
